(19) United States
(12) Patent Application Publication
(10) Pub. No.: US 2011/0191797 A1
(43) Pub. Date: Aug. 4, 2011

(54) SYSTEM FOR CONVERTING CONTENT FROM A MULTIPLE SYSTEM OPERATOR (MSO) TO CONTENT SUITABLE FOR DISTRIBUTION WITHIN A MULTI-DWELLING UNIT

(76) Inventors: John Joseph Lee, Whitby (CA); Linas Underys, Etobicoke (CA); Sasa Veljkovic, Whitby (CA)

(21) Appl. No.: 12/696,661

(22) Filed: Jan. 29, 2010

(51) Int. Cl. H04N 7/167

(52) U.S. Cl. 725/31; 380/200

(57) ABSTRACT

There is disclosed an integrated system for converting content provided by an operator of multiple cable television systems (e.g. a MSO) to content suitable for distribution within a multi-dwelling unit (MDU). A chassis is provided comprising slots for receiving cableCARDs, an input for receiving a cable feed, and an output for transmitting the RF signal. Circuitry within the chassis is configured to extract selected encrypted programs from the cable feed, forward these encrypted programs to the cableCARDs for decryption, and encrypt the decrypted programs using an encryptor such as a Pro:Idiom™ encryptor. A control unit is provided for controlling the operation of at least some of the circuitry within the chassis. The control unit is responsive to instructions sent over a network cable to allow for remote control of the circuitry.

### CROSS-REFERENCE TO RELATED APPLICATIONS

This application is the first application filed for the present invention.

### MICROFICHE APPENDIX

Not Applicable.

### TECHNICAL FIELD

The present invention relates generally to the transmission of digital content to video monitors such as televisions, and in particular to a system for converting content provided by an operator of multiple cable television systems (i.e. an MSO) to content suitable for distribution within a multi-dwelling unit, such as a hotel or hospital.

### DESCRIPTION OF THE PRIOR ART

Operators of multiple cable television systems, generally referred to as multi-system operators (MSOs), are faced with content protection rules stipulated in their agreements with content providers. To comply with these rules, MSOs encrypt their digital content as necessary before delivering it across their network to their subscribers. Typically, the MSO utilizes a central processing facility, referred to as a head end, to receive digital content in the form of one or more digital programs from each of the content providers. A plurality of programs are multiplexed together, encrypted as necessary and modulated onto a Quadrature Amplitude Modulation (QAM) signal for transmission to subscribers. Ten to fifteen standard definition (SD) television programs or two to three high definition (HD) programs are typically multiplexed and transmitted on each QAM signal. A coaxial cable has the ability to carry several frequency multiplexed QAM signals, with one QAM signal per 6 MHz frequency slot in North American cable TV frequency channel plans. At each subscriber site, a terminal device operates to accept the cable feed, select the program(s) the subscriber is permitted to view, and output these programs in a format suitable for display on a video monitor or television set.

A set-top box (STB) is one example of a terminal device that is widely employed by customers of MSOs. Typically, each video monitor has an associated STB that is physically located near the video monitor. When a viewer of the video monitor requests a certain program, the STB first confirms that the user is permitted to view that program, and if so, the STB selects the QAM signal the program is located on, demodulates the selected QAM signal, selects the requested program from the demodulated QAM signal, decrypts the content of the program if necessary, and forwards the program to the video monitor to be displayed.

Recently, it has been mandated that a CableCARD™ be employed in STBs to perform the decryption of encrypted content from the MSO. The primary purpose of the CableCARD™ is to communicate with a headend controller in a central processing facility of the MSO to obtain the necessary information required for a viewer to view a desired program and to decrypt the encrypted programs. The information obtained from the MSO includes information such as entitlement information and secret key information. CableCARDs currently available are typically able to decrypt either one program at a time (a Single Program Stream Card or S-Card) or up to six programs at a time (a Multi-Program Stream Card or M-Card). A CableCARD™ must interconnect with and interact with a host device, which is typically part of the STB or a CableCARD™ ready TV. In order for a CableCARD™ and a host to work in conjunction with one another on a given MSO's network, they must not only validate one another based on the exchange of an electronically loaded certificate, but also must be “paired” by the MSO, which involves entering the CableCARD™ MAC address and Host ID information into the given MSO's billing system and headend controller system.

MSOs often have contracts with multi-dwelling units (MDUs), such as hotels, hospitals, and dormitories. Each video monitor within the MDU is typically able to access and display a particular set of programs purchased by the MDU. In such MDUs, it is generally desired to avoid installing a dedicated STB for each video monitor. This is due to a number of reasons including: aesthetics, likelihood of theft, economics, and difficulty in servicing multiple STBs, each in individual units. Therefore, in these MDUs, a transition device is placed at the MDU, usually at the demarcation point between the MSO's network and the MDU's network, to convert the signals on the cable feed from the MSO into a format that is suitable for distribution within the MDU and suitable for display on the video monitors in the MDU. For example, it is often a requirement that at least some of the content distributed within the MDU network is encrypted, and typically the encryption schemes utilized by the MDU network differs from the encryption scheme applied by the MSO to distribute the content over the MSO network. Whether or not a particular program is encrypted for distribution within the MDU depends on the contract that the MSO has entered into with content providers.

The requirement for a simplistic but secure encryption method for content distribution within a hospitality style MDU has led to the development of a variety of encryption technologies that differ from the encryption technologies utilized by MSOs to distribute their content within the MSO network. The most predominant of the encryption technologies employed in the MDU network is Pro:Idiom™. In fact, many televisions manufactured specifically for MDUs have the ability to directly receive a program encrypted using the Pro:Idiom™ technology and decrypt and display that program on the television.

In transition devices currently utilized at the demarcation point between the MSO and the MDU, the signal from the MSO is split at the transition point and fed to plurality of STBs mounted on a rack. One STB is required for each encrypted program subscribed to by the MDU. Each STB selects its designated program, decrypts it using its CableCARD™, and outputs this program as a baseband signal conforming to a defined protocol (eg. 1394 or HDMI). The output of each STB is then fed to an encryption unit, which performs re-encryption of the decrypted content using an encryption technology endorsed by the MDU, such as a Pro:Idiom™ encryption. The re-encrypted content is then fed to a multiplexer and a QAM modulator, and the result is an encrypted RF signal suitable for distribution within the MDU.

The above-described transition device requires a rack of STBs, with one STB for each program that is to be converted before being delivered into the MDU. For example, if each television set in the MDU was able to display 24 encrypted SD channels, then 24 STBs and the associated encryption units, multiplexers, and QAM modulators would need to be mounted in the rack at the transition point. The use of a rack of this equipment not only takes up a relatively large amount of space, but such an architecture consumes a significant amount of power, not to mention the fact that the use of all of these independent pieces of equipment increases the amount of service time required to maintain the system.

In one implementation of the above-described transition device, a single chassis is provided that houses a Pro:Idiom™ encryption unit, multiplexers and QAM modulators. In this implementation, the output of each of the STBs in the rack is fed into a corresponding input port on the encryption, multiplexer and modulator unit. However, even in this implementation, a rack of STBs, one for each encrypted program, is still required.

Transition devices currently utilized are also limited in their ability to automatically track changes made to the channel map information and make the necessary device configuration changes. For example, if the MSO modifies the channel number assignment of a specific program, the technician is required to make an on-site visit and reconfigure one or more of the STBs at the transition device in order to ensure that the correct program is being transitioned into the MDU on the same QAM frequency and program number.

It is desired to obviate or mitigate at least one of the above-described disadvantages.

### SUMMARY OF THE INVENTION

There are disclosed systems for converting content provided by an operator of multiple cable television systems to content suitable for distribution within a multi-dwelling unit.

In one aspect of the invention, there is provided an integrated system for converting a cable feed including a plurality of programs encrypted by a multi-system operator (MSO) to an RF signal comprising a plurality of programs encrypted for distribution within the network of a multi-dwelling unit (MDU). The system comprises: (a) a chassis comprising slots for receiving at least two CableCARDs, an input for receiving the cable feed, and an output for transmitting the RF signal; and (b) circuitry within the chassis comprising: (i) a plurality of tuners and demodulators for receiving and extracting selected encrypted programs from the cable feed and for forwarding the selected encrypted programs to the at least two CableCARDs for decryption; (ii) an encryptor for encrypting decrypted programs from the at least two CableCARDs; (iii) at least one modulator for modulating the encrypted programs from the encryptor to generate the RF signal; and (iv) a control unit for controlling the operation of at least some of the circuitry within the chassis; the control unit being responsive to instructions sent over a network cable to allow for remote control of the circuitry.

### BRIEF DESCRIPTION OF THE DRAWINGS

Representative embodiments of the invention will now be described by way of example only with reference to the accompanying drawings, in which:

FIG. 1 is a schematic diagram of a central processing facility and an MDU;

FIG. 2 is a schematic of one embodiment of a converter for converting content from an MSO to content suitable for distribution within an MDU;

FIG. 3 shows the chassis of the converter of FIG. 2; and

FIG. 4 is an embodiment of a method of tracking changes in the channel map information and automatically modifying the operation of the converter to accommodate these changes.

It will be noted that throughout the appended drawings, like features are identified by like reference numerals.

### DETAILED DESCRIPTION OF PREFERRED EMBODIMENTS

In general terms, the present invention provides an integrated system for receiving content from an MSO and converting this into content suitable for distribution within an MDU. Specifically, in one embodiment, a single chassis is provided that has the ability to receive a Radio Frequency (RF) signal from the MSO comprising encrypted programs transmitted on frequency multiplexed QAM signals, and output an RF signal comprising programs encrypted using an encryption technology specific to the MDU terminal video monitors (such as Pro:Idiom™ encryption) and transmitted on frequency multiplexed QAM signals. A control unit is integrated within the chassis and can be used to remotely control, via a network connection such as Ethernet, the operation of circuitry within the chassis to control functionalities such as the programs selected by the tuners. Optionally, an embedded cable modem, such as a Data Over Cable Service Interface Specification (DOCSIS)-based cable modem, can be integrated into the chassis to instead allow remote communication with the control unit over the cable of the MSO network. Sensors can also be placed within the chassis to monitor the health of the circuitry components (e.g. to monitor the operating temperature of the components), and this information can be automatically transmitted over the network connection for remote monitoring.

Additionally, as will be explained in detail below, the control unit further comprises a dedicated tracking module for performing the function of automatically recognizing when a channel map change has been made by the MSO and automatically modifying the operation of the system to retrieve the switched program from its new channel map location, whilst still providing the program in the same location on the output RF signal provided to the MDU network.

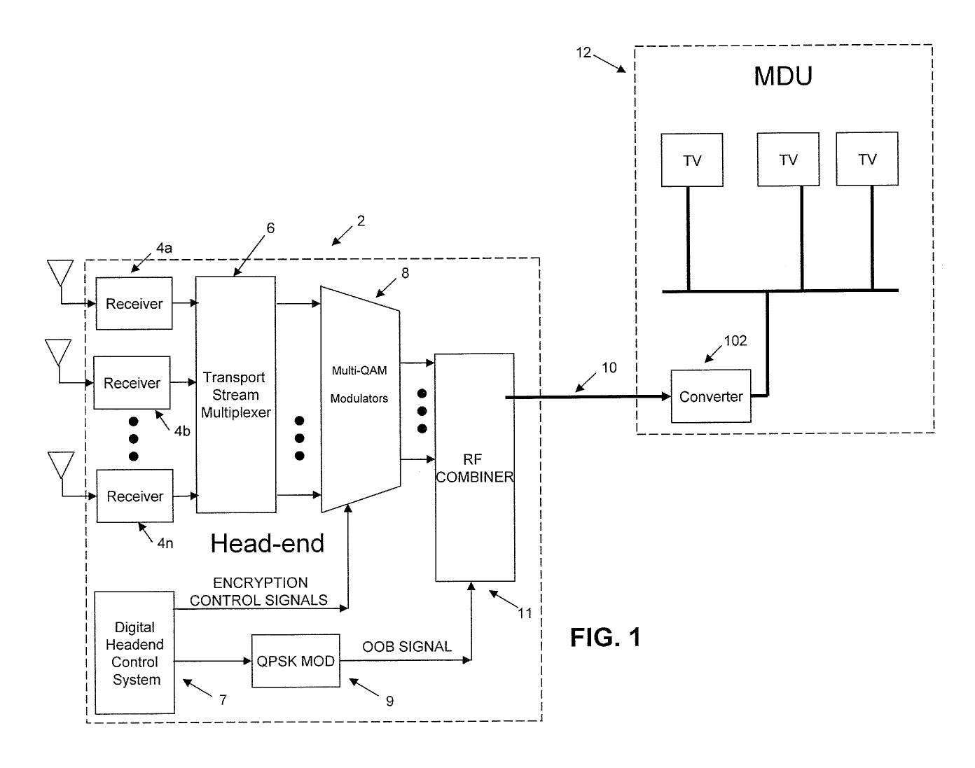

A representative embodiment will now be described with reference to FIGS. 1-4. Turning first to FIG. 1, there is shown a schematic of a central processing facility, such as a head end 2 operated by an MSO. The head end 2 receives programs from each of the digital content providers via an antenna or fiber at each of its receivers (4a to 4n) and sends the digital content to a transport stream multiplexer 6. The transport stream multiplexer multiplexes groups of programs into multiplexed transport streams. Each multiplexed stream is typically referred to as a Multiple Program Transport Stream (MPTS). Each MPTS is sent to one of a plurality of QAM modulators 8, which modulates the MPTS onto a QAM carrier at a specific frequency. The QAM modulators 8 have an interface on them that allows a digital headend control system 7 to send the appropriate encryption messages at the appropriate times so that the appropriate programs in each MPTS can be encrypted using the encryption scheme of the MSO. Therefore, the output of the QAM modulators 8 block is a plurality of MPTSs, each MPTS modulated onto a different QAM frequency. Each MPTS includes a plurality of serial multiplexed programs, and each program may or may not be encrypted depending on the agreement between the MSO and the provider of each program. Typically, most programs will be encrypted.

The headend control system 7 is also responsible for generating an Out of Band (OOB) control signal, which is modulated onto an RF carrier using a QPSK modulator 9. The modulated OOB signal is combined with the frequency multiplex of QAM signals at the RF Combiner 11, and the combined RF signal is transmitted into the MSO network on an optical fibre or coaxial cable 10. As will be explained in more detail below, the OOB signal carries the information and control signals that each CableCARD™/host pair on converter 102 looks for in order to be able to operate in the intended manner. The OOB signal contains information such as the channel map, entitlement information, decryption keys etc. for all programs being transmitted on the network of the MSO.

The cable 10 supplies to a group of subscribers, including the MDU 12, an RF signal comprising the frequency-multiplexed QAM signals and the OOB signal. This RF signal will be referred to herein as the “cable feed”.

In the MDU 12, a converter 102 receives the cable feed and converts this to an RF signal suitable for distribution within the MDU 12. Specifically, in the embodiment described with reference to the figures, the encrypted content from the MSO is decrypted and re-encrypted using Pro:Idiom™ encryption technology in the manner described below. It will be appreciated, however, that in alternative embodiments, other encryption technologies endorsed by the MDU may instead be used in place of the Pro:Idiom™ encryptor to provide encrypted programs suitable for distribution within the MDU. Also, it will be appreciated that it may be the case that none of the programs needs to be encrypted for distribution within the MDU.

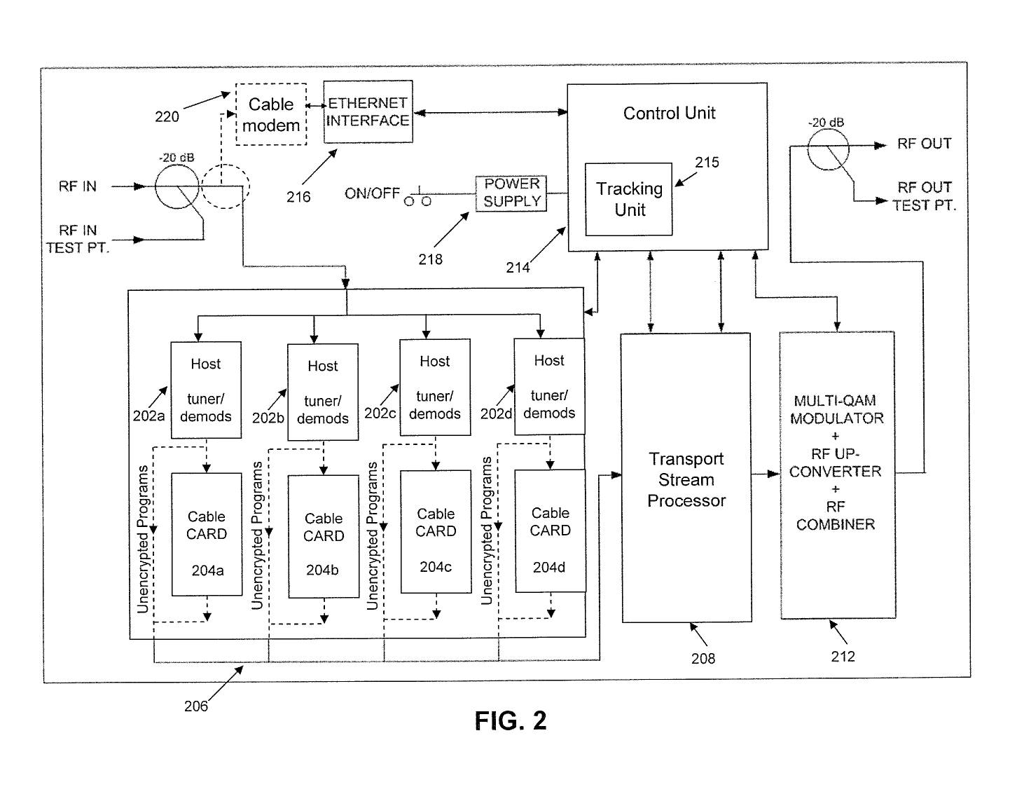

The operation of the converter 102 will now be explained in detail with reference to FIG. 2. The cable feed entering the converter 102 is split and fed to a set of parallel host/CableCARD™ pairs. In the illustrated embodiment, the converter 102 includes four host/CableCARD™ pairs, but more or fewer pairs may be provided, as desired. Each host/CableCARD™ pair operates in the same manner, and therefore only the operation of host 202a and CableCARD™ 204a will be explained in detail below.

Host 202a includes a QPSK tuner/demodulator pair for tuning into and demodulating the OOB signal on the cable feed. The relevant control information on the OOB signal is passed to the CableCARD™ 204a, and as will be explained below, the channel map on the OOB signal is forwarded to the tracking module 215, which checks for any modifications made to the channel map by the MSO. The host 202a also includes six QAM tuner/demodulator pairs, each pair configurable by the host 202a to selectively tune into and demodulate a selected QAM muliplex on the cable feed. Specifically, each tuner selects a QAM signal at a frequency at which one or more desired programs are to be retrieved. The corresponding demodulator performs demodulation of the selected QAM signal and the host 202a extracts the desired program(s) from the baseband MPTS. Due to the provision of six QAM tuner/demodulator pairs, the host 202a is therefore able to provide six parallel MPTSs. The CableCARD™ 204a is a Multi-Program Stream Card (M-Card) and has the ability to decrypt up to six encrypted programs that have been encrypted by the MSO. Therefore, of the six demodulated MPTSs, up to six encrypted programs may be selected and fed in parallel to the CableCARD™ 204a for decryption. Unencrypted programs on the demodulated MPTSs that the viewer is entitled to access can be selected and bypassed around the CableCARD™ 204a directly to bus 206.

It will be understood that hosts 202b-d and CableCARDs 204b-d operate in the same manner as host 202a and CableCARD™ 204a. The output of each host/CableCARD™ pair is provided to bus 206. Therefore, bus 206 can provide up to twenty four decrypted programs, as well as any number of unencrypted programs available on the demodulated MPTSs that the user is entitled to view.

The converter 102 shown in FIG. 2 can receive program content from a maximum of 24 QAM signals. It will be appreciated, however, that the converter 102 can be modified in a straight forward manner to be able to select more or fewer QAM signals by adding or removing QAM tuner/demodulator pairs, and/or the converter 102 can be modified in a straight forward manner to be able to decrypt more or fewer encrypted programs by adding or removing CableCARDs. Advantageously, each host/CableCARD™ pair is modular, thereby making it straight forward to modify the design in FIG. 2 to add or remove one or more pairs.

The bus 206 transports the selected programs to a transport stream processor 208. The transmission over bus 206 is made secure, for example, by using a Digital Rights Management (DRM) scheme implemented by each host 202a-d. The purpose of the transport stream processor 208 is to multiplex the parallel program streams on the bus 206 to create a plurality of multi-program transport streams. The transport stream processor 208 also contains a Pro:Idiom™ encryptor engine, which applies Pro:Idiom™ encryption to the appropriate programs (if necessary) in the plurality of multi-program transport streams.

The output of the transport stream processor 208 is then fed to a multi-QAM modulator and frequency multiplexer unit 212. The purpose of the modulator and frequency multiplexer unit 212 is to modulate each of the multi-program transport streams onto an independent QAM carrier and frequency multiplex the QAM signals to create an RF signal suitable for transmission over a coaxial cable connected to the output of the converter 102.

Advantageously, converter 102 further includes a control unit 214, which includes program instructions stored on a computer readable medium for controlling and/or processing signals to/from the processing units 202, 208, and 212. The control unit 214 also provides a graphical user interface, which a technician can use to remotely configure the operation of the converter. The control unit 214 allows a technician to remotely perform functions such as:
(i) selecting the programs that are desired to be passed through the converter 102. That is, selecting the programs on the cable feed that the converter 102 will tune into, demodulate, decrypt or pass-through, re-encrypt, and re-modulate for distribution within the MDU. This is achieved by the control unit 214 receiving instructions from the technician comprising the selected programs, and then analysing the channel map on the OOB signal and configuring one or more of the host/CableCARD™ pairs in a known manner to select the appropriate programs.
(ii) assigning the QAM frequency and program number that a selected program will take on when distributed through the MDU network.
(iii) investigating the health of various components of the system, such as processing units 202, 208 and 212. For example, a sensor (not shown) can monitor the operating temperature of one or more components and send this information to the control unit 214. The control unit 214 can then notify the technician if overheating is occurring.
(iv) setting standard network configuration parameters for communication, such as Dynamic Host Configuration Protocol (DHCP) parameters, IP address(es), etc.

Advantageously, a network interface, such as an Ethernet interface 216, allows for the remote communication with the control unit 214. This allows a technician to remotely communicate with the control unit 14 over a network such as the Internet. Optionally, a cable modem, such as a DOCSIS-based cable modem 220, can be integrated into the converter 102 to allow for remote communication with the control unit 214 over the MSO network cable. The cable modem 220 is shown in dotted lines to indicate that its inclusion is optional in the embodiment shown in FIG. 2. In embodiments in which the cable modem 220 is included, the cable feed is split and additionally forwarded to the cable modem 220. The output of the cable modem 220 is forwarded to the control unit 214 via the Ethernet interface 216.

As an example, in the embodiment shown in FIG. 2, the control unit 14 can control the twenty four encrypted programs selected and decrypted by the CableCARDs. Therefore, for example, if the MDU 12 purchases a new package of programs, it is not necessary for a technician to visit the MDU 12. Instead, the technician can simply use the Internet to remotely instruct the control unit 214 to control the tuner and demodulator unit 202 to select the new set of programs.

Finally, a power supply 218 is provided to power the functional blocks in the converter 102.

In use, the RF signal having the MSO content transmitted thereon is split and fed in parallel to the four host/CableCARD™ pairs. Each host 202a-d selects and demodulates up to six MPTSs from the cable feed. Specific programs from the MPTSs are forwarded to each respective CableCARD™ 204a-d. Each CableCARD™ 204a-d is able to decrypt up to six programs in parallel. Programs on the MPTS that have not been encrypted by the MSO and that the viewer is entitled to access are selected and bypassed around each CableCARD™ 204a-d directly to bus 206. Bus 206 also receives the decrypted programs from each CableCARD™ 204a-d. Each host 202a-d applies DRM-based protection to the selected programs to ensure the transmission over bus 206 is secure. The selected programs are transported by bus 206 to the transport stream processor 208, which multiplexes and encrypts (as necessary) the programs into new multi-program transport streams. Each multi-program transport stream is modulated and up-converted onto a QAM signal at a specific frequency using multi-QAM modulator and frequency multiplexer unit 212. The output of unit 212 is therefore a signal suitable for distribution over a cable to televisions within the MDU 12. The control unit 214 interacts with the processing blocks to control and monitor settings.

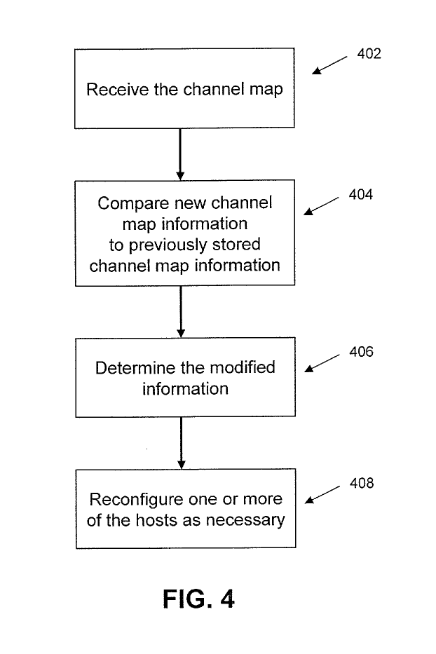

As shown in FIG. 2, control unit 214 also includes a dedicated tracking module 215 for performing the function of automatically recognizing when channel map information is modified by the MSO. As an example, the MSO may modify the channel number, QAM frequency, and/or program number of a program being transitioned into the MDU. The operation of the tracking module 215 is explained with reference to FIG. 4.

In step 402, the tracking module 215 receives from one of the hosts 202a-d the channel map provided by the MSO on the OOB signal. Next, in step 404, the tracking module 215 compares the channel map information from the OOB signal to previously stored channel map information to determine if the channel map information for one or more of the selected programs has been modified.

Assuming the channel map has been modified, in step 406, the tracking module 215 determines the modified information. For example, the assigned channel number, the QAM frequency location, and/or the program number of a selected program on the cable feed may have been modified by the MSO.

Then, in step 408, the tracking module 215 automatically reconfigures one or more of the hosts 202a-d in a known manner to modify the operation of one or more of the tuners and/or demodulators to ensure that the desired program is still properly selected from the cable feed. For example, if the channel number assigned to a particular program is changed, the tracking module 215 ensures that the new channel number is used in order to ensure that the associated tuner is tuned to the appropriate QAM frequency and to ensure that the appropriate program content (video and audio payload) is extracted as defined by the program number assigned to that program. As another example, if the QAM frequency location of a particular program changes, the tracking module 215 re-tunes the associated tuner or employs an unused tuner to tune to the new QAM location. As a further example, if the program number changes, the tracking module 215 ensures that the appropriate content (video and audio payload) is extracted as defined by the new program number assigned to that program.

In this way, the tracking module 215 is able to automatically track the channel map information and automatically reconfigure the CableCARD™/host pairs on the converter 102 to accommodate any changes in the channel map information made by the MSO. This is advantageous over prior art solutions which, for example, require a technician to make an on-site visit to the transition device and reconfigure the channel map of one or more of the STBs in the transition device to update the channel map assignment. By automatically reconfiguring the hosts 202a-d to accommodate a change in the channel map information, the tracking module 215 ensures that each program being transitioned continues to be transitioned into the MDU on the same QAM frequency and same program number.

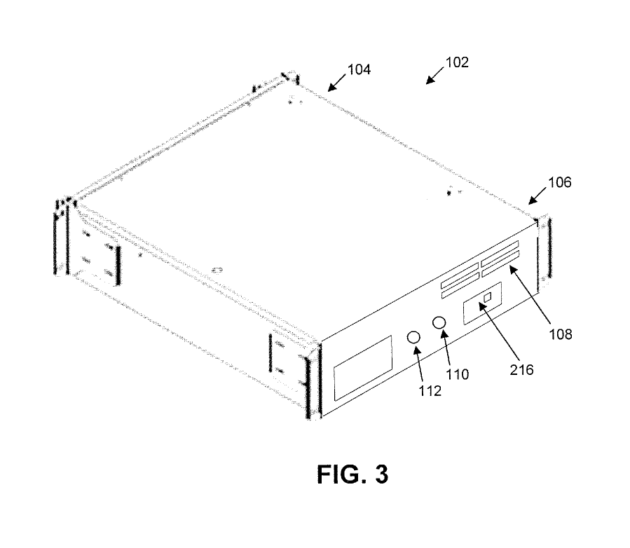

As is shown in FIG. 3, the components and processing blocks described in FIG. 2 can be conveniently fitted within a compact chassis 104 which can readily fit in a standard equipment rack. The converter shown in the embodiment in FIG. 3 is 3 RU high and has a depth of approximately 25″. The rear 106 of the chassis 104 comprises slots 108 for receiving cableCARDs 204a-d. The chassis 104 also comprises an input 110 to receive the coaxial cable from the MSO and an output 112 that can be connected to the coaxial cable that connects the converter 102 to the intended network in the MDU 12. An outer peripheral of the interface 216 is also shown for receiving a network cable.

It will be appreciated that the processing blocks 204, 208, and 212 described in FIG. 2 operate in a manner known in the art. Each of these processing blocks comprise circuitry mounted on one or more printed circuit boards, which can be compactly housed in the chassis 104. The CableCARDs 204a-n and Pro:Idiom™ encryption engine utilized by the transport stream processor 208 are readily available for purchase from commercial suppliers.

Advantageously, the converter 102, which is compactly housed in the chassis 104, can replace a full rack of STBs and associated encryptors, multiplexers and QAM modulators. A STB can only output one program at a time, and therefore, in prior art solutions, twenty four STBs would need to be mounted on a rack, with the output of each STB fed to a dedicated Pro:Idiom™ encryptor, in order to output twenty four encrypted programs in a form suitable for distribution within the MDU 12. Advantageously, the converter 102 does not require the use of any STBs, therefore resulting in cost, maintenance, power and space savings. Moreover, the converter 102 includes an integrated control unit 214, which can be remotely controlled over the Internet, as described above. As an example, the control unit 214 can be remotely instructed to choose any subset of all the programs transmitted on the coaxial cable by the MSO. Therefore, if the MDU 12 purchases a complete new set of channels, the service technician can simply remotely instruct the control unit 214 to control the hosts 202a-d to select the new set of channels. The service technician does not need to visit the MDU 12. The tracking module 215 in control unit 214 tracks changes to the channel map and automatically controls the hosts 202a-d to select the same programs according to the modified channel map. Advantageously, the converter 102 provides a single integrated device for receiving a cable feed from the MSO network and outputting an RF signal comprising programs encrypted (if necessary) using an encryption technology endorsed by the MDU network (such as Pro:Idiom™) and transmitted on frequency multiplexed QAM signals.

Although the invention has been described with reference to certain specific embodiments, various modifications thereof will be apparent to those skilled in the art without departing from the spirit and scope of the invention as outlined in the claims appended hereto.

We claim:

1. An integrated system for converting a cable feed including a plurality of programs encrypted by a multi-system operator (MSO) to an RF signal comprising a plurality of programs encrypted for distribution within the network of a multi-dwelling unit (MDU), the system comprising:
a chassis comprising slots for receiving at least two CableCARDs, an input for receiving the cable feed, and an output for transmitting the RF signal;
circuitry within the chassis comprising:
a plurality of tuners and demodulators for receiving and extracting selected encrypted programs from the cable feed and for forwarding the selected encrypted programs to the at least two CableCARDs for decryption;
an encryptor for encrypting decrypted programs from the at least two CableCARDs; and
at least one modulator for modulating the encrypted programs from the encryptor to generate the RF signal; and
a control unit for controlling the operation of at least some of the circuitry within the chassis; the control unit being responsive to instructions sent over a network cable to allow for remote control of the circuitry.

2. The system of claim 1 wherein the encryptor provides Pro:Idiom™ encryption, and wherein the control unit is configured to control the programs selected by the plurality of tuners and demodulators.

3. The system of claim 2 wherein said network cable is said cable feed, and wherein the circuitry within the chassis further comprises a cable modem for receiving said cable feed; wherein an output of said cable modem is forwarded to the control unit.

4. The system of claim 2 wherein is network cable is an Ethernet cable.

5. The system of claim 2 wherein the chassis comprises slots for receiving at least four cableCARDs, the at least four cableCARDs each being configured to decrypt a plurality of encrypted programs in parallel, and wherein the circuitry within the chassis further comprises a bus to transmit decrypted programs from the cableCARDs to a serial multiplexer and the Pro:Idiom™ encryptor.

6. The system of claim 2 wherein the control unit is configured to control at least one of: (i) the encrypted programs from the cable feed selected using the plurality of tuners and demodulators; and (ii) a QAM frequency and program number for at least one of the encrypted programs from the encryptor.

7. The system of claim 6 wherein the circuitry within the chassis further comprises a sensor, and wherein said control unit is further configured to monitor said sensor and transmit information from said sensor over said network cable.

8. The system of claim 6 wherein said control unit further comprises a tracking module, the tracking module being configured to automatically modify the operation of the plurality of tuners and demodulators based on modifications to a channel map.

9. The system of claim 8 wherein said tracking module is further configured to receive the channel map from the cable feed and determine whether the channel map from the cable feed is modified from a previous channel map and thereby determine said modifications to said channel map.

10. The system of claim 9 wherein said tracking module is further configured to recognize a modification to a channel number assignment, a program number, or a QAM frequency of a program in said channel map.

11. The system of claim 2 wherein the modulators are quadrature amplitude modulators and the demodulators are quadrature amplitude demodulators.

12. The system of claim 5 wherein the chassis has a dimension of 3 RU in height and 25″ in depth.

13. The system of claim 5 wherein the plurality of tuners and demodulators comprises at least twenty four tuner and demodulator pairs, each tuner and demodulator pair for retrieving one Multiple Program Transport Stream (MPTS) from the cable feed.
